(19) United States
(12) Patent Application Publication
(10) Pub. No.: US 2008/0098993 A1
(43) Pub. Date: May 1, 2008

(54) Fuel Pump Relay Module

(75) Inventor: Lawrence Andrew Hoffman, Portland, OR (US)

Correspondence Address: PAUL J. FORDENBACHER;SILICON FOREST PATENT GROUP, 11876 NW TYLER CT., PORTLAND, OR, 97229, US

(73) Assignee: THE HOFFMAN GROUP INTERNATIONAL, LTD., Tortola (VG)

(21) Appl. No.: 11/850,016

(22) Filed: Sep. 4, 2007

Related U.S. Application Data
(60) Provisional application No. 60/824,349, filed on Sep. 1, 2006.

(51) Int. Cl. F02M 37/14; F02M 37/10

(52) U.S. Cl. 123/513; 123/446; 123/512

(57) ABSTRACT

A fuel pump relay module comprising a shock sensor adapted to sense acceleration forces above a predetermined threshold so as to terminate electric power to a fuel pump. Embodiments in accordance with the present invention provide a fuel pump relay module for controlling a fuel pump, comprising a relay including an activation coil, a normally open contact and an armature, the activation coil in operable arrangement with the armature, the armature in operable arrangement to contact the normally open contact when activated by the activation coil and a shock sensor including a normally closed contact adapted to open upon experiencing an acceleration force above a predetermined value, the normally closed contact connected in electrical series with the normally open contact and connected in electrical series with the fuel pump.

### RELATED APPLICATION

This application is a non-provisional application claiming the benefit of U.S. Provisional Application No. 60/824,349, filed Sep. 1, 2006, incorporated herein in its entirety by reference.

### FIELD

The present invention is related to vehicle components, and more particularly, to fuel pump relays.

### BACKGROUND

A fuel pump is an essential component on a vehicle having an internal combustion engine. Fuel has to be pumped from the fuel tank to the engine and delivered under low pressure to the carburetor or under high pressure to the fuel injection system. Some fuel injected engines have two fuel pumps for this purpose: one low pressure/high volume supply pump in the fuel tank and one high pressure/low volume pump on or near the engine.

An electric fuel pump is commonly located inside the fuel tank. The pump creates positive pressure in the fuel lines pushing the gasoline to the engine. In most cars, the fuel pump delivers a constant flow of gasoline to the engine; fuel not used is returned to the tank.

The electric fuel pump is generally operating whenever the car's ignition switch is in the “on” position. Depressing the gas pedal results in the throttle body opening on the engine (metering the air going in) rather than engaging the fuel pump. The ignition switch does not carry the power to the fuel pump, instead it activates a relay which handles the higher current load. A relay is an electrical switch that opens and closes under control of another electrical circuit. The relay is commonly a modular unit found in the fuse or relay box of the vehicle and is easily replaceable.

Some cars with an electronic control unit have safety logic that will shut the electric fuel pump off even if the ignition is “on” if there is no oil pressure, either due to engine bearing damage or a non stalled engine, e.g., in a car accident. In case of an accident, this will also prevent fuel leaking from any ruptured fuel line. Other cars have an additional rollover valve that will shut off the fuel pump in case the car rolls over.

The safety logic and rollover valve described above, and cars without an electronic control unit, are not adequate to shut off the electric fuel pump for many types of accidents. For instance, in an accident, the engine might not be damaged and, therefore maintains a high oil pressure while a fuel line might nonetheless be leaking and contributing to a fire. Similarly, many accidents do not involve a rollover situation.

It would, therefore, be highly desirable to have an improved safety system that provides vehicle manufacturers, aftermarket, and custom vehicle enthusiasts a means to shut off the electric fuel pump quickly after a violent event to prevent fire and explosion due to a fuel line rupture.

### SUMMARY

Embodiments in accordance with the present invention provide a fuel pump relay module for controlling a fuel pump, comprising a relay including an activation coil, a normally open contact and an armature, the activation coil in operable arrangement with the armature, the armature in operable arrangement to contact the normally open contact when activated by the activation coil and a shock sensor, including a normally closed contact adapted to open upon experiencing an acceleration force above a predetermined value, the normally closed contact connected in electrical series with the normally open contact and connected in electrical series with the fuel pump.

In another embodiment, the fuel pump relay module further comprises an oil pressure switch connected in electrical parallel with the normally open contact, the normally closed contact connected in electrical series with the normally open contact and the oil pressure switch.

In another embodiment, the fuel pump relay module further comprises a fusible link connected in electrical series with the normally closed contact, the fusible link adapted to mechanically fail at a predetermined temperature severing electrical communication with the normally closed contact.

In another embodiment, the fuel pump relay module further comprises a visual indicator adapted to respond to the open or closed state of the circuit including the shock sensor, the visual indicator connected in electrical series with the normally closed contact. In another embodiment, the visual indicator comprises a resettable switch adapted to provide a means for closing the normally closed contact.

Embodiments in accordance with the present invention provide a fuel pump relay module, comprising a relay including an activation coil, a normally open contact and an armature, the activation coil in operable arrangement with the armature, the armature in operable arrangement to contact the normally open contact when activated by the activation coil, and a shock sensor including a normally closed contact adapted to open upon experiencing an acceleration force above a predetermined value, the normally closed contact connected in electrical series with the normally open contact.

In another embodiment, the fuel pump relay module further comprises an oil pressure switch connected in electrical parallel with the normally open contact, the normally closed contact connected in electrical series with the normally open contact and the oil pressure switch.

In another embodiment, the fuel pump relay module further comprises a fusible link connected in electrical series with the normally closed contact, the fusible link adapted to mechanically fail at a predetermined temperature severing electrical communication with the normally closed contact.

In another embodiment, the fuel pump relay module further comprises a visual indicator adapted to respond to the open or closed state of the circuit including the shock sensor, the visual indicator connected in electrical series with the normally closed contact. In another embodiment, the visual indicator comprises a resettable switch adapted to provide a means for closing the normally closed contact.

Embodiments in accordance with the present invention provide a fuel pump relay module, comprising a relay including an activation coil, a normally open contact and an armature, the activation coil in operable arrangement with the armature, the armature in operable arrangement to contact the normally open contact when activated by the activation coil, and a shock sensor including a normally closed contact adapted to open upon experiencing an acceleration force above a predetermined value, the normally closed contact connected in electrical series with the activation coil.

In another embodiment, the fuel pump relay module further comprises an oil pressure switch connected in electrical parallel with the normally open contact and the armature, the normally closed contact connected in electrical series with the activation coil and the oil pressure switch.

In another embodiment, the fuel pump relay module further comprises a fusible link connected in electrical series with the normally closed contact, the fusible link adapted to mechanically fail at a predetermined temperature severing electrical communication with the normally closed contact.

In another embodiment, the fuel pump relay module further comprises a visual indicator adapted to respond to the open or closed state of the circuit including the shock sensor, the visual indicator connected in electrical series with the normally closed contact. In another embodiment, the visual indicator comprises a resettable switch adapted to provide a means for closing the normally closed contact.

Embodiments in accordance with the present invention provide a fuel pump relay module comprising a relay including an activation coil, a normally open contact and an armature, the activation coil in operable arrangement with the armature, the armature in operable arrangement to contact the normally open contact when activated by the activation coil, and an oil pressure switch connected in electrical parallel with the normally open contact.

In another embodiment, the fuel pump relay module further comprises a shock sensor including a normally closed contact adapted to open upon experiencing an acceleration force above a predetermined value, the normally closed contact connected in electrical series with the normally open contact and the oil pressure switch.

In another embodiment, the fuel pump relay module further comprises a fusible link connected in electrical series with the normally closed contact, the fusible link adapted to mechanically fail at a predetermined temperature severing electrical communication with the normally closed contact.

In another embodiment, the fuel pump relay module further comprises a visual indicator adapted to respond to the open or closed state of the circuit including the shock sensor, the visual indicator connected in electrical series with the normally closed contact. In another embodiment, the visual indicator comprises a resettable switch adapted to provide a means for closing the normally closed contact.

### BRIEF DESCRIPTION OF THE DRAWINGS

Like reference numbers generally indicate corresponding elements in the figures.

FIG. 1 is a schematic of a vehicle system including a fuel pump relay module, in accordance with an embodiment of the present invention;

FIG. 2 is a schematic of a vehicle system including a fuel pump relay module, in accordance with another embodiment of the present invention;

FIG. 3 is a schematic of a vehicle system including a fuel pump relay module, in accordance with another embodiment of the present invention;

FIG. 4 is a schematic of a vehicle system including a fuel pump relay module, in accordance with another embodiment of the present invention; and

FIG. 5 is a schematic of a vehicle system including a fuel pump relay module, in accordance with another embodiment of the present invention.

### DETAILED DESCRIPTION

References will now be made to embodiments illustrated in the drawings and specific language which will be used to describe the same. It will nevertheless be understood that no limitation of the scope of the invention is thereby intended, such alterations and further modifications in the illustrated devices, as such further applications of the principles of the invention as illustrated therein as being contemplated as would normally occur to one skilled in the art to which the invention relates.

Embodiments in accordance with the present invention relate to a fuel pump relay module having safety elements such that the fuel pump is turned off after a violent event. The fuel pump relay module comprises safety elements in the form of a shock sensor circuit means that detects acceleration forces, wherein, above a predetermined force level, the fuel pump is caused to shut off. The fuel pump relay module is adapted to simply be swapped for the standard fuel pump relay module provided with the vehicle.

It is understood and appreciated that the function of a relay can be provided by an electro-mechanical system and by solid state devices, among others. The embodiments of the present invention are not limited to the specific relay module described, but are applicable to any means having a relay function.

It is understood and appreciated that the term shock sensor as described below is used as a generic term for any means adapted to break an electrical connection in response to an acceleration force above a predetermined value. Such a function may be provided by any of a mechanical, electro-mechanical, electrical, and optical device, among others, and is not limited thereto. The embodiments of the present invention are not limited to a specific shock sensor described, but are applicable to any means having the said function.

By way of example, not limited thereto, the fuel pump relay module is for a motor vehicle having an engine comprising a combustion chamber, an air intake passage defining a throttle bore with a throttle valve therein for controlling the flow of combustion air to the combustion chamber, electric powered fuel injection means effective, when activated, to supply fuel to the combustion chamber in proper quantity and timing for combustion with the combustion air, a spark ignition system effective to initiate combustion of the fuel and air in the combustion chamber, an oil lubrication system including an oil pump powered by the engine while the engine operates, an electric power source. The fuel pump relay module comprises a relay, a shock sensor circuit means, and with or without an oil pressure switch operative to close when the pressure generated by the oil pump exceeds a predetermined value indicative of engine operation. The shock sensor circuit means is effective to provide electrical conduction from the electric power source to the fuel pump via the relay and/or the oil pressure switch when the shock sensor circuit means is not triggered and to sever electric conduction from the electric power source to the fuel pump when the shock sensor circuit means is triggered, having been triggered by an acceleration force above a predetermined value. In another embodiment, the shock sensor circuit means also provides a visual indicator of the trigger status, such as a light emitting diode (LED) that illuminates in response to a triggering event.

The fuel pump relay module operates advantageously to stop the fuel pump so as to stop the flow of fuel after an accident or violent event sufficient to potentially lead to fuel line rupture. Thus, the fuel is no longer supplied to the fuel line so as to prevent continuous leaking from the fuel system with the possibility of fire or explosion.

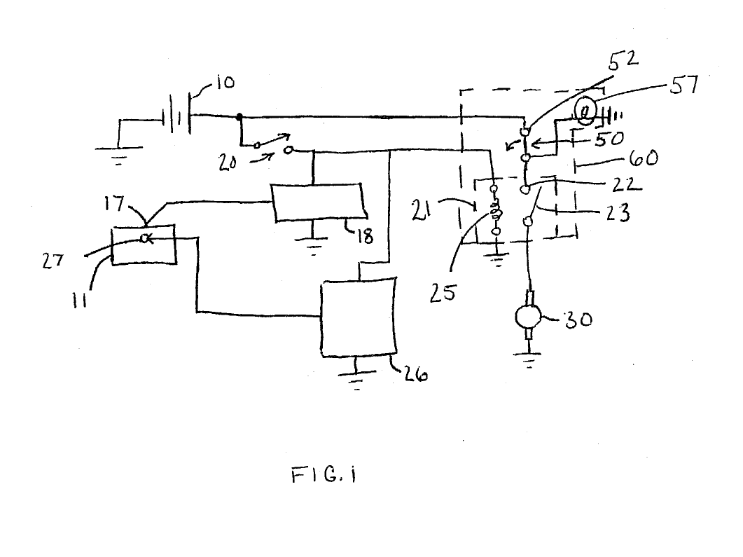

FIG. 1 is a schematic of a vehicle system including a fuel pump relay module 60, in accordance with an embodiment of the present invention. This arrangement is suitable for older cars and in custom cars where the fuel pump is controlled by a relay and is not redundantly controlled by an oil pressure switch.

The shock sensor circuit means effective to control the fuel pump is included in the fuel pump relay module 60 having contacts in series with a relay 21 and an electric power source. Referring to FIG. 1, a motor vehicle is provided with a standard electric power source, symbolized by battery 10. It is understood that the electric power source may also include an alternator, voltage regulator, fuses, etc. An engine 11 includes a fuel injector 17 positioned to inject fuel into an intake passage in response to an electric fuel injection control 18. Fuel injection control 18 may be any typical electric fuel injection control, which provides injection signals at appropriate times for the injection of fuel into the intake passage in proper amount for combustion with intake air and will generally include additional sensors, not shown, for air flow (or pressure), temperature, crankshaft position, etc. Fuel injection control 18 is powered from battery 10 through an ignition switch 20, which is controllable by the vehicle operator to enable or disable engine operation. The fuel injection enabling switch may be the vehicle ignition switch.

The fuel pump relay module 60 comprises a relay 21 having an activation coil 25 and contacts including a normally open contact 22 and an armature 23 effective to contact normally open contact 22 when activated by the activation coil 25. The activation coil 25 is connected in series with the ignition switch 20 and battery 10 so as to conduct when the ignition switch 20 is closed or activated.

It is understood and appreciated that the function of a relay 21 can be provided by an electro-mechanical system as described and by solid state devices, among others. The embodiments of the present invention are not limited to the specific relay described, but are applicable to any means having a relay function.

The fuel pump relay module 60 further comprises a shock sensor 50. The shock sensor 50 comprises a normally closed contact 52, which opens upon experiencing an acceleration force above a predetermined value. The normally closed contact 52 of the shock sensor 50 is connected in series with the normally open contact 22 and armature 23 of the relay 21 and battery 10, so that it will conduct and be powered whenever the ignition switch 20 is closed. The shock sensor 50 is described in more detail below.

The engine 11 is provided with a spark ignition system 26 which provides suitable spark firing pulses to a spark plug 27 located in the combustion chamber of the engine 11 and effective, when it receives such pulses, to initiate combustion of the fuel and air provided to the combustion chamber.

The electric motor driven fuel pump 30 is connected in series with the normally open contact 22 and armature 23 of the relay 21, the normally closed contact 52 of the shock sensor 50, and battery 10. In the engine of FIG. 1, the fuel injection control and spark ignition system are controlled simultaneously by the ignition switch 20 to both cease operation at the same time when the ignition switch 20 is opened by the operator to cease engine operation. The fuel pump 30 is also controlled by the ignition switch 20 through the fuel pump relay module 60.

The normally closed contact 52 of the shock sensor 50 conducts power to the normally open contact 22 in normal operation. Upon a violent event producing an acceleration force above a predetermined value, the shock sensor 50 opens the normally closed contact 52, thus severing conduction to the fuel pump 30.

It is understood and appreciated that the normally closed contact 52 of the shock sensor 50 can be in the circuit either before or after the normally open contact 22.

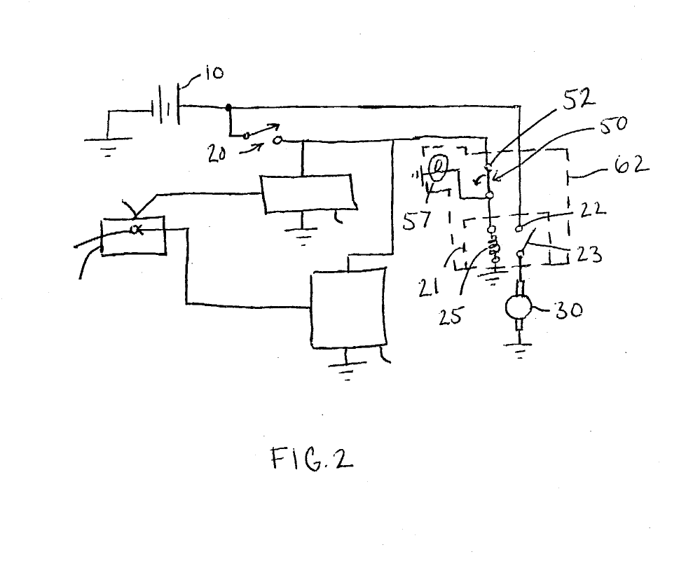

FIG. 2 is a schematic of a vehicle system including a fuel pump relay module 62, in accordance with another embodiment of the present invention. The activation coil 25 is connected in series with the ignition switch 20 and battery 10 so as to conduct when the ignition switch 20 is closed or activated. The normally closed contact 52 of the shock sensor 50 is connected in series with the activation coil 25 of the relay 21 and the battery 10, so that it will conduct and be powered whenever the ignition switch 20 is closed. The normally closed contact 52 of the shock sensor 50 conducts power to the activation coil 25 in normal operation. Upon a violent event producing an acceleration force above a predetermined value, the shock sensor 50 opens the normally closed contact 52, thus severing conduction to the activation coil 25 and, thus, to the fuel pump 30 by opening the armature 23.

It is understood and appreciated that the normally closed contact 52 of the shock sensor 50 can be in the circuit either before or after the activation coil 25.

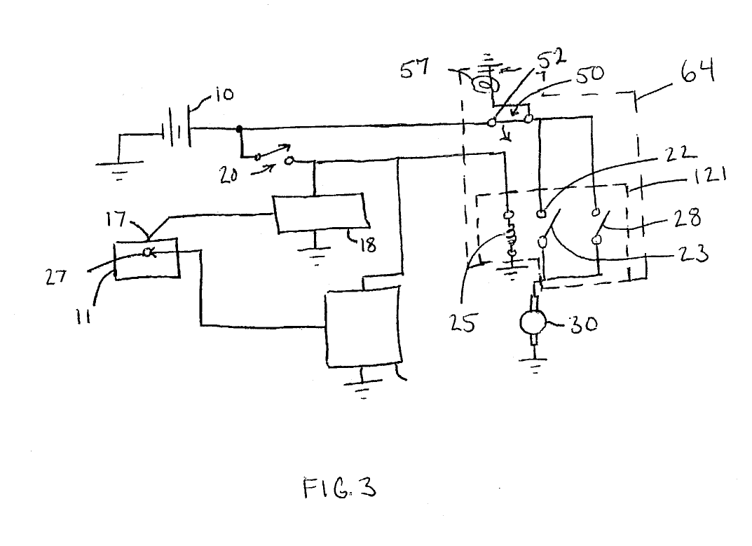

FIG. 3 is a schematic of a vehicle system including a fuel pump relay module 64, in accordance with another embodiment of the present invention. The shock sensor circuit means effective to control the fuel pump 30 is included in the fuel pump relay module 64 having contacts in series with not only with the normally open contact 22 and armature 23, or the activation coil 25, as described for the embodiments of FIGS. 1 and 2, but also with an oil pressure switch 28, with the fuel pump 30 connected also to the oil pressure switch 28. The fuel pump relay module 64 is particularly suited to vehicles provided with a relay module powering an electric motor driven fuel pump 30 and having the oil pressure switch 28 across the contacts as a backup for a fuel pump relay. The arrangement of FIG. 3 is suitable for newer cars where the fuel pump 30 is also controlled by an oil pressure switch with fuel pump relay module 64 replacing both a fuel pump relay and a pressure switch.

Referring to FIG. 3, a motor vehicle is provided with a standard electric power source, symbolized by the battery 10. It is understood that the electric power source may also include a standard alternator, voltage regulator, fuses, etc. An engine 11 includes a fuel injector 17 positioned to inject fuel into an intake passage in response to an electric fuel injection control 18. The fuel injection control 18 may be any typical electric fuel injection control, which provides injection signals at appropriate times for the injection of fuel into the intake passage in proper amount for combustion with intake air and will generally include additional sensors, not shown, for air flow (or pressure), temperature, crankshaft position, etc. The fuel injection control 18 is powered from the battery 10 through a fuel injection enabling switch, which is controllable by the vehicle operator to enable or disable engine operation. The fuel injection enabling switch may be the standard vehicle ignition switch 20.

The fuel pump relay module 64 comprises a relay 121 having contacts including a normally open contact 22 and an armature 23 effective to contact the normally open contact 22 when activated by an activation coil 25. The activation coil 25 is connected in series with the ignition switch 20 and battery 10 so as to conduct when the ignition switch 20 is closed or activated. In addition, the fuel pump relay module 64 comprises an oil pressure switch 28 in parallel with the normally open contact 22 and the armature 23, as will be described below.

The fuel pump relay module 64 further comprises a shock sensor 50. The shock sensor 50 comprises a normally closed contact 52 which opens upon experiencing an acceleration force above a predetermined value. The normally closed contact 52 of the shock sensor 50 is connected in series with both the normally open contact 22 and armature 23 of the relay 121 and battery 10, and the oil pressure switch 28, so that it will conduct and be powered whenever the ignition switch 20 is closed. The shock sensor 50 is described in more detail below.

The engine 11 is provided with a spark ignition system 26 which provides suitable spark firing pulses to a spark plug 27 located in the combustion chamber of the engine 11 and effective, when it receives such pulses, to initiate combustion of the fuel and air provided to the combustion chamber. The engine 11 is also provided with the oil pressure switch 28 connected across the normally open contact 22 and the armature 23 and, thus, connecting, when closed, the fuel pump 30 in series with the battery 10. The oil pressure switch 28 is responsive to the oil pressure in an oil lubrication system of the engine 11, the lubricating system including an oil pump mechanically powered by the engine 11 while the engine operates: that is, while the engine crankshaft is rotating. Such a lubricating system including the pump and oil pressure switch is well known in engine design and is thus not shown in the Figure, except for switch 28, in accordance with an embodiment of the present invention.

The electric motor driven fuel pump 30 is connected in series with the normally open contact 22 and the armature 23 of the relay 121 and battery 10, as well as connected in series with the oil pressure switch 28. In the engine of FIG. 3, the fuel injection control and spark ignition system are controlled simultaneously by the ignition switch 20 to both cease operation at the same time when the ignition switch 20 is opened by the operator to cease engine operation. The fuel pump 30 is also controlled by the ignition switch 20 through the fuel pump relay module 64.

The normally closed contact 52 of the shock sensor 50 conducts power to the normally open contact 22 and the oil pressure switch 28 in normal operation. Upon a violent event producing an acceleration force above a predetermined value, the shock sensor 50 opens the normally closed contact 52, thus, severing conduction to the fuel pump 30, regardless of the status of the oil pressure switch 28.

It is understood and appreciated that the normally closed contact 52 of the shock sensor 50 can be in the circuit either before or after the normally open contact 22, and before or after the oil pressure switch 28.

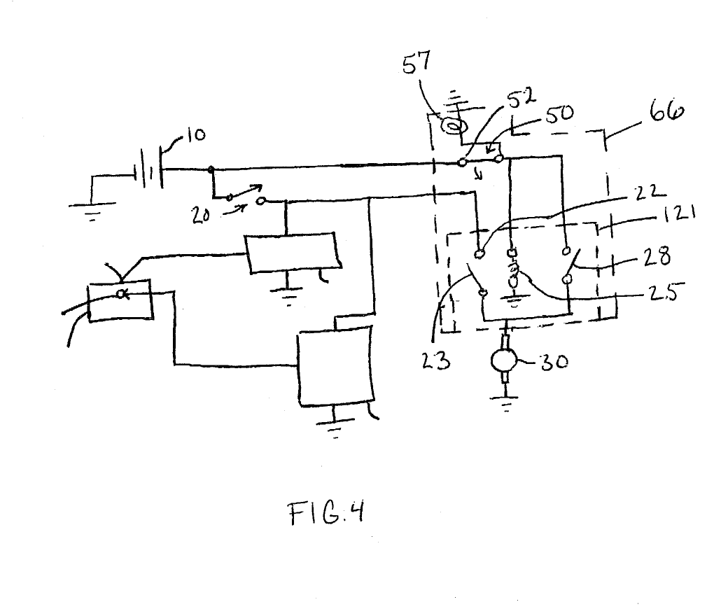

FIG. 4 is a schematic of a vehicle system including a fuel pump relay module 66, in accordance with another embodiment of the present invention. The fuel pump relay module 66 comprises a relay 121 having contacts including a normally open contact 22 and an armature 23 effective to contact the normally open contact 22 when activated by an activation coil 25. The activation coil 25 is connected in series with the ignition switch 20 and battery 10 so as to conduct when the ignition switch 20 is closed or activated. In addition, the fuel pump relay module 64 comprises an oil pressure switch 28 in parallel with the normally open contact 22 and the armature 23, as will be described below

The normally closed contact 52 of the shock sensor 50 is connected in series with the activation coil 25 and the battery 10, and the oil pressure switch 28, so that it will conduct and be powered whenever the ignition switch 20 is closed. The normally closed contact 52 of the shock sensor 50 is effective to conduct power to the activation coil 25 and the oil pressure switch 28 in normal operation. Upon a violent event producing an acceleration force above a predetermined value, the shock sensor 50 opens the normally closed contact 52, thus severing conduction to the activation coil 25 and the oil pressure switch 28 and, thus, to the fuel pump 30, regardless of the state of the oil pressure switch 28.

Referring again to FIGS. 1-4, the fuel pump relay module 60,62,64,66 further comprises a visual indicator 57, in accordance with other embodiments of the present invention. The visual indicator 57 responds to the state of the circuit including the shock sensor 50; whether it is open or closed. As shown in the figures, the visual indicator 57 is connected in series with the normally closed contact 52 of the shock sensor 50. When the shock sensor 50 is not triggered, the visual indicator 57 indicates an active status, in the case of a light emitting diode (LED), turns on. When the shock sensor 50 triggers upon a triggering event, the normally closed contact 52 opens, breaking the circuit of the visual indicator 57 and the visual indicator 57 indicates a triggered status, in the case of an LED, turns off. In this way, the user has a visual indication of the electrical status of the fuel pump relay module. It is appreciated that other circuit configurations for the visual indicator 57 may be utilized so as to provide a visual indication of the electrical status of the fuel pump relay module. The visual indicator 57 is placed within the circuit suitable for the particular purpose.

The visual indicator 57 may be any device capable of communicating the electrical status of the fuel pump relay module. Such devices include, but are not limited to, a mechanical flag, an incandescent filament bulb, a light emitting diode, among others.

Referring again to FIGS. 1-4, the fuel pump relay module 60,62,64,66 further comprises a visual indicator 57 that is also a resettable switch, in accordance with other embodiments of the present invention. The visual indicator 57 provides a visual indication as described above, but also provides a means for resetting or closing the open normally closed contact 52 after the triggering event, similar to that of a resettable circuit breaker. In an embodiment wherein the visual indicator 57 is a mechanical flag, the flag may pop up or move from a first position in such a way to indicate the status of the fuel pump relay module 60,62,64,66, the flag being operable to be moved back to the first position resetting or closing the normally closed contact 52.

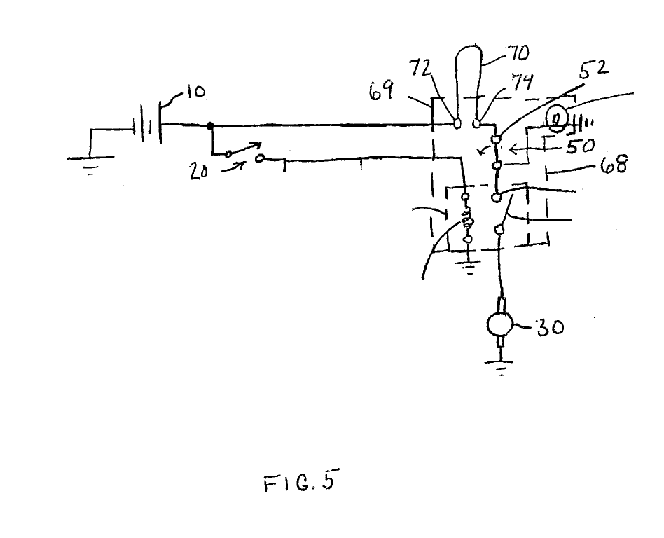

FIG. 5 is a schematic of a vehicle system including a fuel pump relay module 68, in accordance with another embodiment of the present invention. The fuel pump relay module 68 is substantially the same as the embodiment of FIG. 1 with the addition of a fusible link 70 connected in series at first link contact 72 and second link contact 74 between the battery 10 and the fuel pump 30. The fusible link 70 is adapted to break an electrical connection upon a predetermined temperature. The fusible link 70 extends beyond the housing 69 of the fuel pump relay module 68, such that it can be located in a predetermined location. The predetermined location is that location(s) that may be susceptible to a fire after an accident or catastrophic event. Upon exposure to a predetermined level of heat or fire, the fusible link 70 mechanically fails so as to sever the electrical connection between the battery 10 and the fuel pump 30, terminating the operation of the fuel pump 30 so as to stop the flow of fuel after an accident or violent event sufficient to potentially lead to fuel line rupture and fire. Thus, the fuel is no longer supplied to the fuel line so as to prevent continuous leaking from the fuel system with the possibility of fire or explosion.

In an embodiment in accordance with the present invention, the fusible link 70 is a wire suitable to be routed to one or more locations of interest. When exposed to excessive heat or fire, the wire melts breaking the electrical connection. The wire may be of sufficient length so that is may be routed extensively to locations of interest, such as, but are not limited to, the passenger compartment and engine compartment of the vehicle.

In another embodiment in accordance with the present invention, the fusible link 70 is a wire with a plurality of solder elements, each suitable to be located in one or more locations of interest. When exposed to excessive heat or fire, a solder element melts breaking the electrical connection. Each solder element may be provided within a housing suitable for mounting to a structure at locations of interest, such as, but are not limited to, the passenger compartment and engine compartment of the vehicle

In another embodiment in accordance with the present invention, the fusible link 70 is provided in a fuel pump relay module 68 that does not also include a shock sensor circuit means.

Shock sensors are known in the art. They come in many forms and operate in one of many different principles. Shock sensors are known as piezoelectric accelerometers, silicon MEMS accelerometers, and magnetometers, among others.

By way of example of a piezoelectric accelerometer, a piezoelectric assembly is contained within the sealed housing; a piezoelectric assembly consisting of a seismic mass preloaded to a quartz element stack. The force acting on the quartz element is proportional to the acceleration in accordance with Newton's Law: F=ma. The element yields an electrical charge proportional to the force, and, therefore, to the acceleration. Electrodes collect and wires transmit the charge to a signal conditioner that may be remote or built into the accelerometer. Sensors containing built-in signal conditioners are classified as Integrated Electronics Piezoelectric (IEPE) or voltage mode; charge mode sensors require external or remote signal conditioning. Once the charge is conditioned by the signal conditioning electronics, the signal is available for control.

A circuit is provided in the fuel pump relay module that reacts to the electrical charge or signal that is above a predetermined value; a value associated with a violent collision that has the potential of causing fuel line damage or other hazardous conditions associated with fuel delivery, such as, but not limited to 75 G±20%/10 msec. The circuit reacts by terminating conduction to the fuel pump, thereby terminating the conveyance of the fuel.

Single axis, biaxial, and triaxial accelerometers are known in the art. A single axis accelerometer can detect forces associated with acceleration predominantly along one axis. Since the exact position of the fuel pump relay module is not consistent from one vehicle to another, it is anticipated that in an embodiment in accordance with the present invention, a plurality of single axis accelerometers are used to detect acceleration forces from a plurality of directions. A biaxial accelerometer is able to detect forces associated with acceleration about two orthogonal axes. A triaxial accelerometer is able to detect forces associated with acceleration about the three orthogonal axes and, therefore, a single triaxial accelerometer can detect acceleration forces from a plurality of directions regardless of initial relay position.

A variety of mechanical configurations are available to perform the transduction principles of a piezoelectric accelerometer. These configurations are defined by the nature in which the inertial force of an accelerated mass acts upon the piezoelectric material. Configurations include shear, flexural beam and compression, among others.

Shear mode designs bond, or “sandwich”, the sensing crystals between a center post and seismic mass. A compression ring or stud applies a preload force required to create a rigid linear structure. Under acceleration, the mass causes a shear stress to be applied to the sensing crystals. By isolating the sensing crystals from the base and housing, shear accelerometers excel in rejecting thermal transient and base bending effects. Also, the shear geometry lends itself to small size.

Flexural mode designs utilize beam-shaped sensing crystals, which are supported to create strain on the crystal when accelerated. The crystal may be bonded to a carrier beam that increases the amount of strain when accelerated. This design offers a low profile, light weight, excellent thermal stability, and an economical price. Insensitivity to transverse motion is also an inherent feature of this design.

Compression mode accelerometers are available in three types of designs: upright, inverted, and isolated. Upright compression designs sandwich the piezoelectric crystal between a seismic mass and rigid mounting base. An elastic stud or screw secures the sensing element to the mounting base. When the sensor is accelerated, the seismic mass increases or decreases the amount of force acting upon the crystal, and a proportional electrical output results. The larger the seismic mass is, the greater the stress and, hence, the output are. Inverted compression designs isolate the sensing crystals from the mounting base, reducing base bending effects. Isolated compression designs reduce erroneous outputs due to base strain and thermal transients. These benefits are achieved by mechanically isolating the sensing crystals from the mounting base and utilizing a hollowed-out seismic mass that acts as a thermal insulation barrier.

An example of a silicon MEMS accelerometer is the Analog Devices ADXL330 accelerometer that is 4×4-mm (1.45 mm thick) in a 16-lead Leadframe Chip Scale Package (LFCSP), housing a monolithic 3-axis accelerometer and the signal conditioning electronics. The low power (200 μA at 2V) unit measures acceleration with a minimum full-scale range of ±2 g. The accelerometer has a shock rating of 10,000 g and features stable zero g bias, accurate sensitivity, and bandwidth adjustment with a single capacitor. Measurement capabilities include dynamic acceleration resulting from motion, shock, or vibration.

The description of the vehicle system provided above is only an example so as to describe the embodiments of the fuel pump relay module. It is understood that the fuel pump relay module can be used in many types of systems having a fuel pump. The fuel pump relay module is not limited to any particular engine configuration, and corresponding fuel supply system, so long as there is an electrically powered fuel pump.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A fuel pump relay module for controlling a fuel pump, comprising:
a relay including an activation coil, a normally open contact and an armature, the activation coil in operable arrangement with the armature, the armature in operable arrangement to contact the normally open contact when activated by the activation coil; and
a shock sensor including a normally closed contact adapted to open upon experiencing an acceleration force above a predetermined value, the normally closed contact connected in electrical series with the normally open contact and connected in electrical series with the fuel pump.

2. The fuel pump relay module of claim 1, further comprising:
an oil pressure switch connected in electrical parallel with the normally open contact, the normally closed contact connected in electrical series with the normally open contact and the oil pressure switch.

3. The fuel pump relay module of claim 1, further comprising:
a fusible link connected in electrical series with the normally closed contact, the fusible link adapted to mechanically fail at a predetermined temperature severing electrical communication with the normally closed contact.

4. The fuel pump relay module of claim 1, further comprising:
a visual indicator adapted to respond to the open or closed state of the circuit including the shock sensor, the visual indicator connected in electrical series with the normally closed contact.

5. The fuel pump relay module of claim 4, wherein the visual indicator comprises a resettable switch adapted to provide a means for closing the normally closed contact.

6. A fuel pump relay module, comprising:
a relay including an activation coil, a normally open contact and an armature, the activation coil in operable arrangement with the armature, the armature in operable arrangement to contact the normally open contact when activated by the activation coil; and
a shock sensor including a normally closed contact adapted to open upon experiencing an acceleration force above a predetermined value, the normally closed contact connected in electrical series with the normally open contact.

7. The fuel pump relay module of claim 6, further comprising:
an oil pressure switch connected in electrical parallel with the normally open contact, the normally closed contact connected in electrical series with the normally open contact and the oil pressure switch.

8. The fuel pump relay module of claim 6, further comprising:
a fusible link connected in electrical series with the normally closed contact, the fusible link adapted to mechanically fail at a predetermined temperature severing electrical communication with the normally closed contact.

9. The fuel pump relay module of claim 6, further comprising:
a visual indicator adapted to respond to the open or closed state of the circuit including the shock sensor, the visual indicator connected in electrical series with the normally closed contact.

10. The fuel pump relay module of claim 9, wherein the visual indicator comprises a resettable switch adapted to provide a means for closing the normally closed contact.

11. A fuel pump relay module, comprising:
a relay including an activation coil, a normally open contact and an armature, the activation coil in operable arrangement with the armature, the armature in operable arrangement to contact the normally open contact when activated by the activation coil; and
a shock sensor including a normally closed contact adapted to open upon experiencing an acceleration force above a predetermined value, the normally closed contact connected in electrical series with the activation coil.

12. The fuel pump relay module of claim 11, further comprising:
an oil pressure switch connected in electrical parallel with the normally open contact and the armature, the normally closed contact connected in electrical series with the activation coil and the oil pressure switch.

13. The fuel pump relay module of claim 11, further comprising:
a fusible link connected in electrical series with the normally closed contact, the fusible link adapted to mechanically fail at a predetermined temperature severing electrical communication with the normally closed contact.

14. The fuel pump relay module of claim 11, further comprising:
a visual indicator adapted to respond to the open or closed state of the circuit including the shock sensor, the visual indicator connected in electrical series with the normally closed contact.

15. The fuel pump relay module of claim 14, wherein the visual indicator comprises a resettable switch adapted to provide a means for closing the normally closed contact.

16. A fuel pump relay module, comprising:
a relay including an activation coil, a normally open contact and an armature, the activation coil in operable arrangement with the armature, the armature in operable arrangement to contact the normally open contact when activated by the activation coil; and
an oil pressure switch connected in electrical parallel with the normally open contact.

17. The fuel pump relay module of claim 16, further comprising:
a shock sensor including a normally closed contact adapted to open upon experiencing an acceleration force above a predetermined value, the normally closed contact connected in electrical series with the normally open contact and the oil pressure switch.

18. The fuel pump relay module of claim 16, further comprising:
a fusible link connected in electrical series with the normally closed contact, the fusible link adapted to mechanically fail at a predetermined temperature severing electrical communication with the normally closed contact.

19. The fuel pump relay module of claim 16, further comprising:
a visual indicator adapted to respond to the open or closed state of the circuit including the shock sensor, the visual indicator connected in electrical series with the normally closed contact.

20. The fuel pump relay module of claim 19, wherein the visual indicator comprises a resettable switch adapted to provide a means for closing the normally closed contact.
